(19) United States
(12) Patent Application Publication
(10) Pub. No.: US 2018/0048559 A1
(43) Pub. Date: Feb. 15, 2018

(54) APPARATUS ASSIGNING CONTROLLER AND APPARATUS ASSIGNING METHOD

(71) Applicant: H3 Platform, Inc., New Taipei City (TW)

(72) Inventor: Yu-Ching Chou, New Taipei City (TW)

(73) Assignee: H3 Platform, Inc., New Taipei City (TW)

(21) Appl. No.: 15/286,591

(22) Filed: Oct. 6, 2016

(30) Foreign Application Priority Data
Aug. 10, 2016 (TW) 105125444

(51) Int. Cl. H04L 12/761; H04L 29/08; H04L 29/06

(52) U.S. Cl. CPC H04L 45/16; H04L 67/42; H04L 67/10

(57) ABSTRACT

An apparatus assigning controller is provided. The apparatus assigning controller includes a plurality of peripheral apparatuses, a processor, and a communication interface. The peripheral apparatuses and the communication interface meet the peripheral component interconnect express. The processor is coupled to the peripheral apparatuses by a bus meeting the peripheral component interconnect express. The communication interface is coupled to the processor. A server is coupled to the apparatus assigning controller through the communication interface. When the server is started, the processor receives an apparatus scanning requirement of the server, and provides a predetermined apparatus information to the server, wherein the server reserves a corresponding hardware resource and a corresponding memory space according to the predetermined apparatus information. The processor assigns the peripheral apparatuses to the server, wherein a number of the peripheral apparatuses of each kind is not greater than a number of the peripheral apparatuses of each kind recorded in a predetermined apparatus information.

### CROSS-REFERENCE TO RELATED APPLICATION

This application claims the priority benefit of Taiwan application serial no. 105125444, filed on Aug. 10, 2016. The entirety of the above-mentioned patent application is hereby incorporated by reference herein and made a part of this specification.

### BACKGROUND OF THE INVENTION

### 1. Field of the Invention

The present invention relates to an apparatus assigning technology, and particularly to an apparatus assigning controller and an apparatus assigning method.

### 2. Description of Related Art

With the development of the cloud network technology, the demand for cloud computing and data access is growing, many manufacturers provide hardware device virtualization technology to improve the equipment utilization rate of the server. The hardware device virtualization technology can be applied on various peripheral apparatus, such as the peripheral apparatus like the network interface controller (NIC) adopting the peripheral component interconnect express (PCIe), RAID HBA, etc.

In building the cloud computing centers, in order to meet the requirements of massive computation and data access, the servers are increased and the peripheral apparatuses such as general purpose computing on graphics processing units (PGPU), network card, data storage controller card are installed in the cloud computing center continuously, so as to supply the sufficient hardware. However, the installed peripheral apparatuses can only be utilized on the server, and when the server idled, the peripheral apparatuses are also idled and the unnecessary wastage is caused.

Therefore, the abovementioned situation will cause the hardware apparatus redundancy of the cloud computing center on the server, and the cost of building the cloud computing centers for the manufacturers is also increased. Regardless of the usage of the server, lots of the peripheral apparatuses are installed on all of the servers, and the unnecessary peripheral apparatuses may not only increase the cost on building the cloud computing center, they may also increase the power consumption, so the current trend of green energy is not satisfied.

### SUMMARY OF THE INVENTION

The present invention provides an apparatus assigning controller and an apparatus assigning method, dynamically assigning a plurality of peripheral apparatuses to the server through additionally disposed apparatus assigning controller, so that the using efficiency of the server can be increased and the waste of energy can be avoided.

The apparatus assigning controller of the invention includes a plurality of peripheral apparatuses, a processor, and a communication interface. The peripheral apparatus meets the peripheral component interconnect express. The processor is coupled to the peripheral apparatuses by a bus meeting the peripheral component interconnect express. The communication interface is coupled to the processor, and meets the peripheral component interconnect express. A server is coupled to the apparatus assigning controller through the communication interface. When the server is started, the processor receives an apparatus scanning requirement of the server, and provides a predetermined apparatus information to the server, wherein the server reserves a corresponding hardware resource and a corresponding memory space according to the predetermined apparatus information. The processor assigns the peripheral apparatuses to the server, wherein a number of the peripheral apparatuses of each kind is not greater than a number of the peripheral apparatuses of the kinds recorded in a predetermined apparatus information.

In an embodiment of the invention, the processor virtualizes the peripheral apparatuses into a plurality of virtual apparatuses through a single root I/O virtualization specification, and dynamically assigns the virtual apparatuses to the server.

In an embodiment of the invention, the peripheral apparatus includes physical apparatus. The apparatus assigning controller is configured to dynamically assign the physical apparatus to the server.

In an embodiment of the invention, the processor dynamically assigns the peripheral apparatus to the server according to the apparatus request of the server.

In an embodiment of the invention, when the apparatus request of the server is changed, the processor retrieves or reassigns the peripheral apparatus to the server according to the apparatus request of the server.

In an embodiment of the invention, when the hot-plug event occurs on the peripheral apparatus, the processor retrieves or reassigns the peripheral apparatus to the server according to the apparatus request of the server.

In an embodiment of the invention, the step of assigning the peripheral apparatuses to the server includes: virtualizing the peripheral apparatuses into a plurality of virtual apparatuses through a single root 1/O virtualization specification, dynamically assigning the virtual apparatuses to the server, and make the virtual apparatuses coupled to the server.

In an embodiment of the invention, the peripheral apparatus includes physical apparatus, and the step of assigning the peripheral apparatus to the server includes: making the physical apparatus coupled to the apparatus assigning controller.

In an embodiment of the invention, the step of assigning the peripheral apparatus to the server include: assigning the peripheral apparatus to the server according to the apparatus request of the server.

In an embodiment of the invention, the step of assigning the peripheral apparatus to the server further includes: when the apparatus request of the server is changed, retrieving or reassigning the peripheral apparatus to the server according to the apparatus request of the server.

In an embodiment of the invention, the step of assigning the peripheral apparatus to the server further includes: when the hot-plugging occurs on the peripheral apparatus, retrieving or reassigning the peripheral apparatus to the server according to the apparatus request of the server.

Based on the above, when the server is just started, the apparatus assigning controller and the apparatus assigning method of the embodiment of the invention provide predetermined apparatus information to the server, so that the server can reserve the hardware resource and the memory space in advance through the predetermined apparatus information, therefore, the plurality of peripheral apparatuses assigned by the apparatus assigning controller can be supported through the previously reserved hardware resource and the memory space in the server, and the apparatus assigning controller is prevented from struggling to provide more peripheral apparatuses to the server. In other words, through the corresponding technology of reserving the hardware resource, the failure of the supporting of the corresponding server is not concerned when the apparatus assigning controller is assigning the peripheral apparatus to the server through dynamic assigning. By doing so, the embodiment of the invention can effectively increase using efficiency of the server and avoid the waste of the energy.

To make the above features and advantages of the disclosure more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates a block diagram of the apparatus assigning controller of an embodiment of the invention.

FIG. 2 illustrates a circuit schematic diagram of the apparatus assigning controller of an embodiment of the invention.

FIG. 3 illustrates an assigning schematic diagram of the peripheral apparatus of an embodiment of the invention.

FIG. 4 illustrates an assigning schematic diagram of the peripheral apparatus of another embodiment of the invention.

FIG. 5 illustrates a flow chart of the apparatus assigning method of an embodiment of the invention.

### DESCRIPTION OF THE EMBODIMENTS

The embodiment of the present invention provides an assigning method of the peripheral apparatus and an apparatus assigning controller in the connection relation between the peripheral apparatus and the server, so that the hardware resource and the memory space able to provide maximum usage level are reserved when the server is started, so as to let the apparatus assigning controller perform the assigning of the peripheral apparatus. Also, the peripheral apparatus may be retrieved or reassigned directly in dynamic method according to the apparatus request or the hot-plugging of the server, and there is no need to turn on or turn off of the power of the server or the apparatus assigning controller again. By doing so, the saving of the energy can be achieved effectively and the using efficiency of the peripheral apparatus can be increased.

Among the full text of the specification of the invention (include the claims), the used term “couple (or connect)” may be referred to as any direct or indirect connection method. For instance, if “first device is connected to second device” is described in the paragraph, then it should be interpreted as “first device may be directly connected to second device”, or “first device may be indirectly connected to second device through other device or some kind of connection method”. Moreover, elements/components/steps with same reference numerals represent same or similar parts in the drawings and embodiments. Same numerals or same terms of the elements/components/steps used in different embodiments may be referred to the cross-reference instruction mutually.

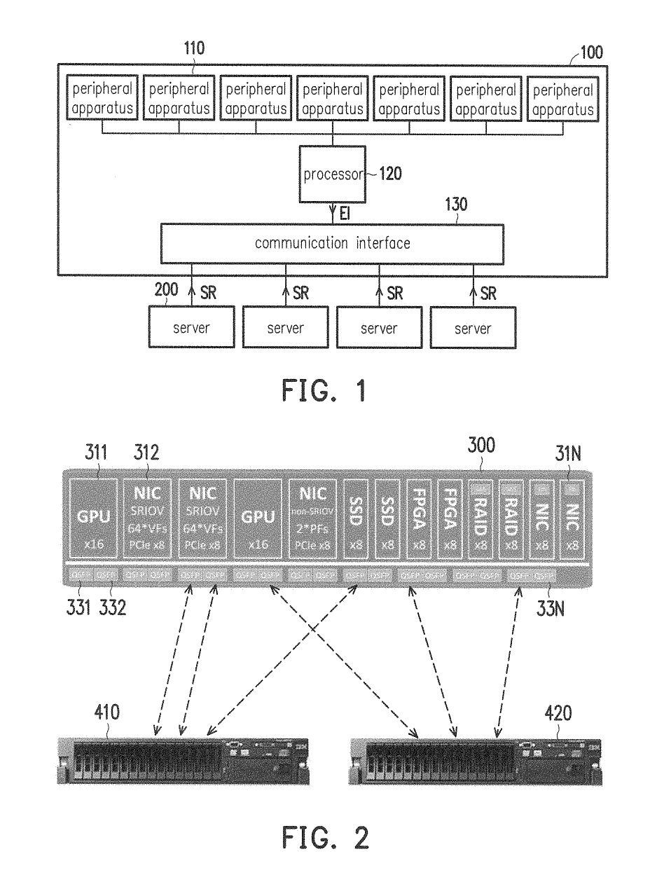

FIG. 1 illustrates a block diagram of the apparatus assigning controller of an embodiment of the invention, please referring to FIG. 1, the apparatus assigning controller 100 includes a plurality of peripheral apparatuses 110, a plurality of servers 200, and a communication interface 130. In an embodiment of the invention, the peripheral apparatus 110 and the communication interface 130 meets the peripheral component interconnect express. The processor 120 is coupled to the peripheral apparatus 110 and the communication interface 130, wherein the processor 120 may be coupled to the peripheral apparatus 110 and the communication interface 130 through the bus (not shown) meeting the peripheral component interconnect express. The plurality of servers 200 is coupled to the apparatus assigning controller 100 through the communication interface 130. In an embodiment of the invention, the peripheral apparatus 110 and the communication interface 130 may be coupled to each other through the bus meeting the peripheral component interconnect express.

In the embodiment, the apparatus assigning controller 100 is configured to dynamically assign the peripheral apparatuses 110 to one or a plurality of physical servers 200. In the embodiment, the apparatus assigning controller 100 is configured to assign the coupling status between the peripheral apparatus 110 and the server 200.

The processor 110 may be configured to execute the apparatus assigning method of each embodiment of the invention, the processor 110 is central processing unit (CPU), for example, so as to achieve the apparatus assigning method described in the invention through the program of the software or the logic circuit of the hardware.

The peripheral apparatus 110 may include a graphics processing unit (GPU), a general-purpose computing on graphics processing unit (GPGPU), a non-volatile memory express (NVMe), a solid state disk (SSD), a network interface controller (NIC), a field-programmable gate array (FPGA), a redundant array of independent disk (RAID) or any other similar apparatus or the combination thereof. For instance, if the various peripheral apparatuses support single root I/O virtualization (SR-IOV) specification, the apparatus assigning controller can virtualize the peripheral apparatus into a plurality of virtual apparatuses supporting the single root I/O virtualization technique, and further include one or a plurality of PCIe physical function (PF). In addition, each physical function may correspond to at least one virtual function virtual function (VF), wherein the virtual function may be used and assigned as virtual machine (single root I/O virtualization SRIOV is transformed into multi-root I/O virtualization MRIOV for the usage). That is, the single root I/O virtualization specification is referred to an extended function of the PCIe, so that the physical peripheral apparatus shows a plurality of virtual apparatuses. For instance, a physical function can be divided into 64 virtual functions correspondingly. Therefore, in the embodiment, the processor 120 can further virtualize the peripheral apparatuses 110 into a plurality of virtual apparatuses through the single root I/O virtualization specification, and dynamically assign the virtual apparatuses according to the apparatus request of the server 110. However, in the embodiment, the peripheral apparatus may also include a plurality of physical apparatuses providing the physical function directly, the invention is not limited thereto.

The communication interface 130 may include a plurality of ports for high-speed communication transmission, and these ports meet the peripheral component interconnect express. In the embodiment, the communication interface 130 is coupled to the server 200 through the cable, so as to provide the data transmission function between the peripheral apparatus 110 and the server 120. However, in the embodiment of the invention, the coupling method between the apparatus assigning controller 100 and the server 200 can be decided according to the transmission interface adopted by the person applying the present invention, and the mutual communication is performed through the peripheral component interconnect express, the invention is not limited thereto.

The server 200 can be the apparatus having the central processing unit (CPU) like the rack-mount or tower servers, desktop computer, laptop, etc.

For instance, FIG. 2 illustrates schematic diagram of the apparatus assigning controller of an embodiment of the invention. Please referring to FIG. 2, the apparatus assigning controller 300 can include the peripheral apparatuses 311, 312, 313, . . . 31N and the communication interface 320, and the communication interface 320 can include ports 331, 332, . . . , 32M, wherein N and M is a positive integer greater than 1. In the embodiment, the ports 331, 332, . . . , 32M can be Quad-SFP transceiver. As illustrated in FIG. 2, the peripheral apparatuses 311, 312, 313, . . . , 31N can be graphic processor, network interface card, solid state disk, programmable gate arrays, and disk arrays, etc.

In the embodiment, the apparatus assigning controller 300 is coupled to the servers 410, 420 through the ports 331, 332, . . . , 32M. In the embodiment, the apparatus assigning controller 300 can use the processor to assign the peripheral apparatuses 311, 312, 313, . . . , 31N to the server 410 or server 420 respectively according to the apparatus request of the servers 410, 420 respectively, so that the operation system of the servers 410, 420 can use the functions of the peripheral apparatuses 311, 312, . . . , 31 according to each apparatus request. That is, the apparatus assigning controller 300 can choose to couple to the servers 410, 420 through the ports 331, 332, . . . , 32M according to the apparatus request of the servers 410, 420, so that the peripheral apparatuses needed by each of the servers are further provided to the servers 410, 420 respectively. For instance, the network interface card and the solid state disk are assigned to the server 410, and the graphic processor, programmable gate arrays, and disk arrays are assigned to the server 420. In the embodiment, the apparatus request of the server is referred to the hardware resource needed when the server is executing the calculation or the data accessing operation, such as the graphic processor needed when the server is executing the calculation of graphic processing, or the data storage apparatus needed when the server is executing the data accessing operation, etc. Possibly, due to the insufficiency of the hardware resource of the server, it is necessary to propose the apparatus request to the apparatus assigning controller 300. In the embodiment, the apparatus request of each of the servers 410, 420 is determined according to the content of the work in process respectively, the invention is not limited thereto.

It should be noted that the type and number of the peripheral apparatuses and communication interface of the invention are not limited to the illustration in FIG. 2, and the number of the servers is also not limited to the illustration in FIG. 2, either. In the embodiment, the type and number of the peripheral apparatuses, communication interfaces, and the servers can be arbitrarily disposed according to the user's demand.

Referring to FIG. 1 again, in an embodiment of the invention, the apparatus assigning controller 100 is configured to be coupled to a plurality of servers 200 (for example, 10 to 16 servers, but in the invention, the number is not limited thereto). When the server 200 is started, the processor 110 receives the apparatus scanning requirement SR of the server 200 respectively through the communication interface 130. The processor 110 can provide the predetermined apparatus information EI to each server 200 respectively according to the apparatus scanning requirement SR. By doing so, the server 200 reserves the hardware resource and the memory space respectively according to the predetermined apparatus information EI, so that the processor 110 can assign the peripheral apparatus 110 to the server 200. It should be noted that the peripheral apparatuses 110 can be a plurality of PCIe apparatuses of different types and number. In the embodiment, a number of the peripheral apparatuses of each kind is not greater than a number of the peripheral apparatuses of each kind recorded in a predetermined apparatus information, and the server 200 receives the same predetermined apparatus information EI respectively.

For example, 3 graphic processors and 4 network interface cards may be disposed in the apparatus assigning controller 100 recorded in the predetermined apparatus information EI, and each server 200 reserves the hardware resource and the memory space able to be configured to execute 3 graphic processors and 4 network interface cards first. When the server 200 is started, the processor 120 assigns 2 graphic processors and 1 network interface card to one of the server 200 according to one of the apparatus request of the server 200. Or, the processor 120 assigns all of the graphic processors and network interface cards to one of the server 200 according to one of the apparatus request of the server 200. That is, the number of each kind of the peripheral apparatuses 110 able to be received by each server 200 is not greater than the number recorded in the predetermined apparatus information, and the assignable number of each kind of the peripheral apparatuses 110 is equal to the number of the kinds recorded in the predetermined apparatus information at most. By doing so, the apparatus assigning controller 100 can prevent the bandwidth and memory space for the execution of at least one of the function of the peripheral apparatuses 110 from restriction due to resource allocation after the operation system of any one of the servers 200 is started.

Specifically, after the server 200 is started, the server 200 transmits the apparatus scanning requirement to the apparatus assigning controller 100, for the purpose of scanning the apparatus assigning controller 100 to obtain the related apparatus information about the kinds and number of the peripheral apparatuses 110 contained therein, so as to provide the usage for the operation system of the started server 200. However, the apparatus assigning controller 100 lets the started server 200 able to directly scan the apparatus information of the peripheral apparatus 110. Or, after the turning on of the server 200 is completed, the apparatus assigning is performed by the assigning controller 100. In the case of assigning controller 100 performing the apparatus assigning after the turning on of the server 200 is completed, the apparatus assigning controller 100 outputs the predetermined apparatus information EI to the started server 200. Therefore, each started server 200 reserves the corresponding hardware resource and memory space according to the predetermined apparatus information EI. The hardware resource is the amount or serial number of the communication bus, for example.

In an embodiment of the invention, the predetermined apparatus information EI can be configured as the related apparatus information of various kinds and maximum amount of the peripheral apparatuses able to be assigned by the apparatus assigning controller 100, so that the hardware resource and the memory space able to provide maximum usage level are reserved after the predetermined apparatus information EI is received. In such a way, after the operation system of the server 200 is started, the processor 120 may retrieve the peripheral apparatus 110 assigned to the server 200 according to the apparatus request of the server 200, and reassign the peripheral apparatus 110 to the server 200 currently having the apparatus request. That is, after the operation system of the server 200 is started, the number of the peripheral apparatuses 110 assigned by the apparatus assigning controller 100 to the server 200 is not limited by the insufficient hardware resource, bandwidth, or memory space reserved by the server 200, and the peripheral apparatus 110 is dynamically assigned to the server 200. The apparatus assigning controller 100 can assign lots of, even all of the peripheral apparatuses 110 for the execution of the operation system of the server 200 according to the apparatus request of the server 200.

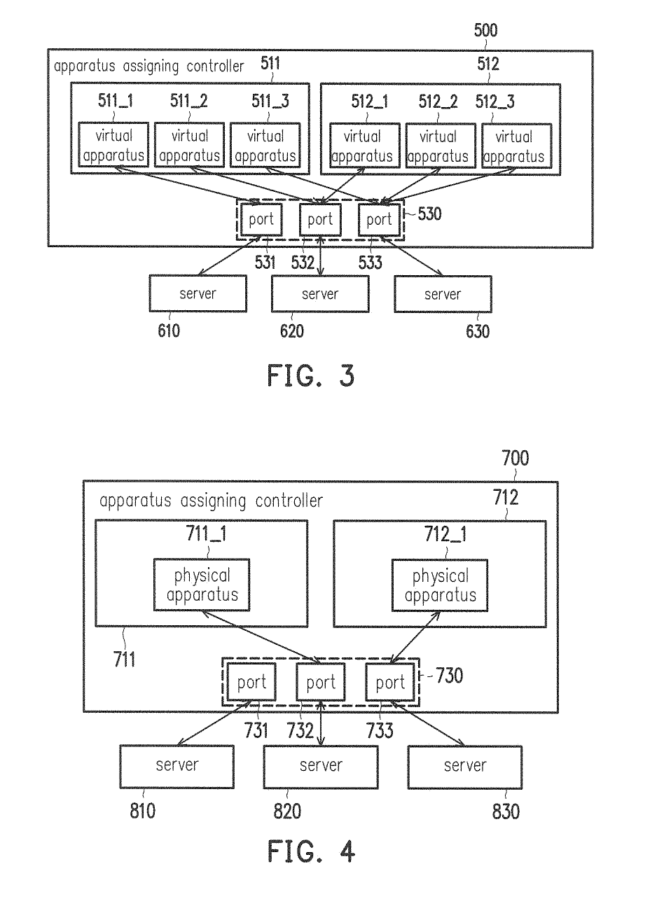

For instance, FIG. 3 illustrates an assigning schematic diagram of the peripheral apparatus of an embodiment of the invention. Please referring to FIG. 3, the apparatus assigning controlling device 500 includes the peripheral apparatuses 511, 512, and the communication interface 530 includes ports 531, 532, 533. In the embodiment, the peripheral apparatuses 511, 512 produce 3 virtual apparatuses 511_1, 511_2, 511_3, 512_1, 512_3, 512_3 having virtual function respectively. The processor of the apparatus assigning controlling device 500 assigns the virtual apparatuses 511_1, 511_2, 511_3, 512_1, 512_3, 512_3 according to the apparatus request of the servers 610, 620, 630. In the embodiment, it is assumed that the server 630 has the highest apparatus request, followed by the server 620, and the server 610 has the least apparatus request. Therefore, the virtual apparatus 511_1 can be coupled to the server 610 through the port 531. The virtual apparatuses 511_2, 511_3 can be coupled to the server 620 through the port 532. The virtual apparatuses 512_1, 512_2, 512_3 can be coupled to the server 630 through the port 533. The servers 610, 620, 630 can determine the coupling number of the virtual apparatuses according to each apparatus request respectively. Besides, even though the server 630 needs higher apparatus request, the insufficient resource assigning to the server 630 won't be caused on the apparatus assigning controlling device 500 due to the insufficient amount of PCIe buses and memory space reserved by the server 630. It should be noted that the embodiment is not limited to the assigning situation of the virtual apparatus, it can also be adapted to the assigning situation of the physical apparatus.

Referring to FIG. 1 again, in an embodiment of the invention, the apparatus assigning controller 100 assigns the peripheral apparatus 110 according to the apparatus request of each server 200 respectively, so, when one of the servers 200 doesn't need to use the function of the peripheral apparatus 110 (for instance, the factors such as server idling, damage, or turning off), the apparatus assigning controller 100 can dynamically reassign the server 200, and the apparatus assigning controller 100 and the server 200 need no re-turning on. That is, the assigning method of the apparatus assigning controller 100 is about determining whether the peripheral apparatus 100 is retrieved or reassigned according to the using status of the server 200, so that the server 200 having the apparatus resource request can effectively use the physical function and the virtual function of the peripheral apparatus 110.

For instance, FIG. 4 illustrates another assigning schematic diagram of the peripheral apparatus of an embodiment of the invention. Please referring to FIG. 4, the apparatus assigning controlling device 700 includes the peripheral apparatuses 711, 712, and the communication interface 730 includes ports 731, 732, 733. In the embodiment, the peripheral apparatuses 711, 712 have the physical apparatuses 711_1, 712_1 having the physical function respectively. The apparatus assigning controlling device 700 can assign the servers 810, 820, 830 to the physical apparatuses 711_1, 712_1 according to the apparatus request of the servers 810, 820, 830. It is assumed that the servers 820 and 830 have the apparatus request of the physical apparatus, and the server 810 doesn't. Therefore, the peripheral apparatus 711 can be coupled to the server 820 through the port 732. The peripheral apparatus 712 can be coupled to the server 830 through the port 732. That is, the servers 820 and 830 can obtain the coupling with the physical apparatuses 711_1, 712_1 according to the apparatus request, and the insufficient resource assigning to the servers 820 and 830 won't be caused on the apparatus assigning controlling device 700 due to the server 810 occupying the resource of the physical apparatus. It should be noted that the embodiment is not limited to the assigning situation of the physical apparatus, it can also be adapted to the assigning situation of the virtual apparatus.

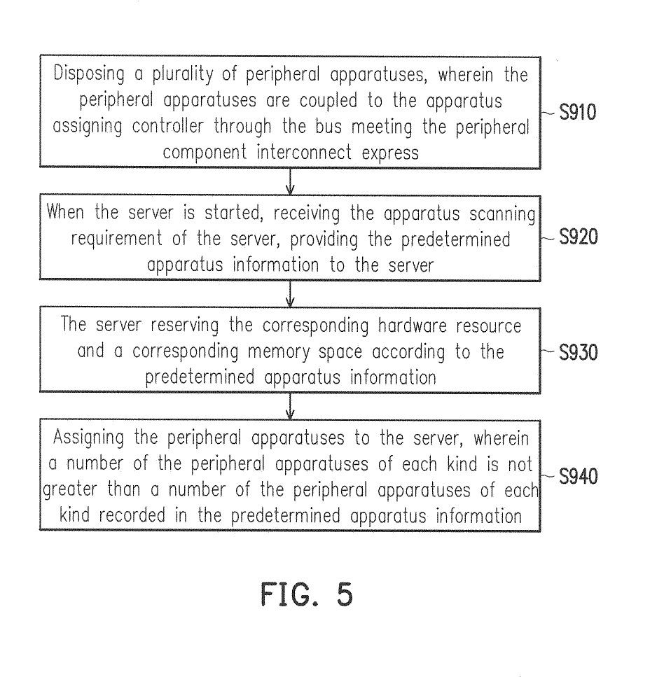

FIG. 5 illustrates a flow chart of the apparatus assigning method of an embodiment of the invention. Please referring to FIG. 1, FIG. 5 simultaneously, the method in the embodiment is at least adapted to the apparatus allocating controller 100 and server 200 in FIG. 1. In step S910, the apparatus assigning controller 100 can dispose a plurality of peripheral apparatuses 110, wherein the peripheral apparatuses 100 are coupled to the apparatus assigning controller through a bus meeting a peripheral component interconnect express. In the step S920, when the server 200 is started, the processor 120 of the apparatus assigning controller 100 receives the apparatus scanning requirement SR of the server 200, and provide the predetermined apparatus information EI to the server 200 as a response. In step S930, the server 200 reserves the corresponding hardware resource and a corresponding memory space according to the predetermined apparatus information EI. In the step S940, the processor 120 of the apparatus assigning controller 100 assigns the peripheral apparatuses 100 to the server 200, wherein a number of the peripheral apparatuses 110 of each kind is not greater than a number of the peripheral apparatuses 100 of the kinds recorded in a predetermined apparatus information EI. Therefore, the server 200 can be coupled to the processor 120 of the apparatus assigning controller 100 through the communication interface 130, and reserves the hardware resource and the memory space of the highest request, so that the processor 120 assigns the peripheral apparatus 110 according to the the apparatus request of the server 200.

In addition, the teachings, suggestions, and embodiments of the apparatus assigning controller and the related apparatus features of the server and the apparatus assigning method of the invention can be fully illustrated by the above descriptions related to each of the embodiments of FIG. 1 to FIG. 4, and are not repeated herein.

Based on the above, at least one server able to be coupled to the apparatus assigning controller of the embodiment of the invention reserves the maximum number of the PCIe buses and memory space when the server is just started, therefore, the plurality of peripheral apparatuses assigned by the apparatus assigning controller can be supported through the previously reserved hardware resource and the memory space in the server, and the apparatus assigning controller is prevented from struggling to provide more peripheral apparatuses to the server. In other words, through the corresponding technology of reserving the hardware resource, the failure of the supporting of the corresponding server is not concerned when the apparatus assigning controller is assigning the peripheral apparatus to the server through dynamic assigning. By doing so, the embodiment of the invention can effectively increase using efficiency of the server and avoid the waste of the energy. Besides, about the occurrence of the hot-plugging on the peripheral apparatus, the apparatus assigning controller of the embodiment of the invention adjusts the rest of the peripheral apparatuses to the server by the method of dynamic assigning, and the server and the apparatus assigning controller needs no re-turning on.

It will be apparent to those skilled in the art that various modifications and variations can be made to the disclosed embodiments without departing from the scope or spirit of the invention. In view of the foregoing, it is intended that the invention covers modifications and variations provided that they fall within the scope of the following claims and their equivalents.

What is claimed is:

1. An apparatus assigning controller, comprising:
a plurality of peripheral apparatuses, meeting a peripheral component interconnect express;
a processor, coupled to the peripheral apparatuses by a bus meeting the peripheral component interconnect express;
a communication interface, coupled to the processor, and meeting the peripheral component interconnect express,
wherein at least one server is coupled to the apparatus assigning controller through the communication interface,
when the at least one server is started, the processor receives an apparatus scanning requirement of the at least one server, provides a predetermined apparatus information to the at least one server, wherein the at least one server reserves a corresponding hardware resource and a corresponding memory space according to the predetermined apparatus information, and the processor assigns the peripheral apparatuses to the at least one server,
wherein a number of the peripheral apparatuses of each kind is not greater than a number of the peripheral apparatuses of each kind recorded in a predetermined apparatus information.

2. The apparatus assigning controller according to claim 1, wherein the processor virtualizes the peripheral apparatuses into a plurality of virtual apparatuses through a single root I/O virtualization specification, and dynamically assigns the virtual apparatuses to the at least one server.

3. The apparatus assigning controller according to claim 1, wherein the peripheral apparatuses comprise at least one physical apparatus, the apparatus assigning controller is configured to dynamically assign the at least one physical apparatus to the at least one server.

4. The apparatus assigning controller according to claim 1, wherein the processor dynamically assigns the peripheral apparatuses to the at least one server according to an apparatus request of the at least one server.

5. The apparatus assigning controller according to claim 4, wherein when the apparatus request of the at least one server is changed, the processor recovers or reassigns the peripheral apparatuses to the at least one server according to the apparatus request of the at least one server.

6. The apparatus assigning controller according to claim 4, wherein when a hot-plug event occurs on at least one of the peripheral apparatuses, the processor recovers or reassigns the peripheral apparatuses to the at least one server according to the apparatus request of the at least one server.

7. An apparatus assigning method, adapted to an apparatus assigning controller, wherein the apparatus assigning method comprising:
disposing a plurality of peripheral apparatuses, wherein the peripheral apparatuses are coupled to the apparatus assigning controller through a bus meeting a peripheral component interconnect express;
when at least one server is started, receiving an apparatus scanning requirement of the at least one server, providing a predetermined apparatus information to the at least one server;
the at least one server reserves a corresponding hardware resource and a corresponding memory space according to the predetermined apparatus information; and
assigning the peripheral apparatuses to the at least one server, wherein a number of the peripheral apparatuses of each kind is not greater than a number of the peripheral apparatuses of each kind recorded in the predetermined apparatus information.

8. The apparatus assigning method according to claim 7, wherein a step of assigning the peripheral apparatuses to the at least one server comprising:
virtualizing the apparatuses into a plurality of virtual apparatuses through a single root I/O virtualization specification; and
dynamically assigning the virtual apparatuses to the at least one server, and making the virtual apparatuses coupled to the server.

9. The apparatus assigning method according to claim 7, wherein the peripheral apparatuses comprise at least one physical apparatus, and, a step of assigning the peripheral apparatuses to the at least one server comprises:
making the at least one physical apparatus coupled to the apparatus assigning controller.

10. The apparatus assigning method according to claim 7, wherein a step of assigning the peripheral apparatuses to the at least one server comprising:
assigning the plurality of peripheral apparatuses to the at least one server according to an apparatus request of the at least one server.

11. The apparatus assigning method according to claim 10, wherein a step of assigning the peripheral apparatuses to the at least one server further comprising:
when the apparatus request of the at least one server is changed, recovering or reassigning the peripheral apparatuses to the at least one server according to the apparatus request of the at least one server.

12. The apparatus assigning method according to claim 10, wherein a step of assigning the peripheral apparatuses to the at least one server further comprising:
when a hot-plugging occurs on at least one of the peripheral apparatuses, retrieving or reassigning the peripheral apparatuses to the at least one server according to the apparatus request of the at least one server.
